(19) United States
(12) Patent Application Publication
(10) Pub. No.: US 2018/0367326 A1
(43) Pub. Date: Dec. 20, 2018

(54) AUTOMATIC CONNECTION SWITCHING FOR MEETING ROOM MANAGEMENT DEVICES

(71) Applicant: MICROSOFT TECHNOLOGY LICENSING, LLC, Redmond, WA (US)

(72) Inventor: Ergo ESKEN, Miiduranna (EE)

(73) Assignee: MICROSOFT TECHNOLOGY LICENSING, LLC, Redmond, WA (US)

(21) Appl. No.: 15/627,743

(22) Filed: Jun. 20, 2017

(51) Int. Cl. H04L 12/18; G06F 1/28; H04Q 1/02

(52) U.S. Cl. CPC H04L 12/1822; H04Q 1/03; G06F 1/28

(57) ABSTRACT

Technologies are described for automatic connection switching for meeting room management devices. For example, in a meeting room, where a meeting room management device is communicatively coupled to an in-room computer for access to a network, a connection of a client device capable of facilitating an online meeting to a connection module associated with the meeting room management device may be detected. The meeting room management device may then be disengaged at least partially from a connection to the network associated with facilitating the online meeting, and the client device may be allowed to connect to the network such that the client device facilitates the online meeting.

### BACKGROUND

Meeting rooms are often equipped with a dedicated computer and audio video equipment. Modern meeting rooms may also include a meeting room management device for facilitating online meetings in conjunction with participants physically in a meeting room. Meeting room management devices may control audio/video equipment in the meeting room, as well as, exchange data over a dedicated or general purpose network to present content, audio component, and video component of an online meeting. In some scenarios, attendants may prefer to use their own device a (e.g., laptop, a tablet, a smart phone, etc.) to manage the online meeting with their own choice of VoIP apps, for example. Typical configurations may, however, require unplugging the audio/video devices from the meeting room management device and connecting to the preferred user device. Subsequently, the original configuration (that is, cable connections) may need to be restored. Often, the IT department may have restricted the access to the main unit of the meeting room management device or cable removal may be blocked.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to implementation of automatic connection switching for meeting room management devices. For example, a connection of a computing device capable of facilitating an online meeting to a connection module associated with a meeting room management device may be detected. The meeting room management device may then be disengaged at least partially from a connection to a network associated with facilitating the online meeting, and the computing device may be allowed to connect to the network such that the computing device facilitates the online meeting.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a display diagram illustrating an example network environment where a system for automatic connection switching for meeting room management devices may be implemented;

FIG. 2A includes a display diagram conceptually illustrating automatic connection switching from a meeting room management device to a client device through a connection module integrated into a meeting room management device;

FIG. 2B includes a display diagram conceptually illustrating automatic connection switching from a meeting room management device to a client device through a connection module integrated into a meeting room management device, where in-room ancillary devices are allowed to maintain their separate connection to the network;

FIG. 2C includes a display diagram conceptually illustrating automatic connection switching from a meeting room management device to a client device through a separate connection module;

FIG. 2D includes a display diagram conceptually illustrating automatic connection switching from a meeting room management device to a client device through a separate connection module, where in-room ancillary devices are allowed to maintain their separate connection to the network;

FIG. 3 includes a display diagram illustrating conceptually an example set of actions and components for implementing automatic connection switching for meeting room management devices;

FIG. 4 is a networked environment, where a system according to embodiments may be implemented;

FIG. 5 is a block diagram of an example computing device, which may be used to implement automatic connection switching for meeting room management devices; and

FIG. 6 illustrates a logic flow diagram of a method to implement automatic connection switching for meeting room management devices, arranged in accordance with at least some embodiments described herein.

### DETAILED DESCRIPTION

As briefly described above, embodiments are directed to automatic connection switching for meeting room management devices. For example, in a meeting room, where a meeting room management device is communicatively coupled to an in-room computer for access to a network, a connection of a client device capable of facilitating an online meeting to a connection module associated with the meeting room management device may be detected. The meeting room management device may then be disengaged at least partially from a connection to the network associated with facilitating the online meeting, and the client device may be allowed to connect to the network such that the client device facilitates the online meeting.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture such as a computer program product or computer readable media. The computer program'product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for automatic connection switching for meeting room management devices. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

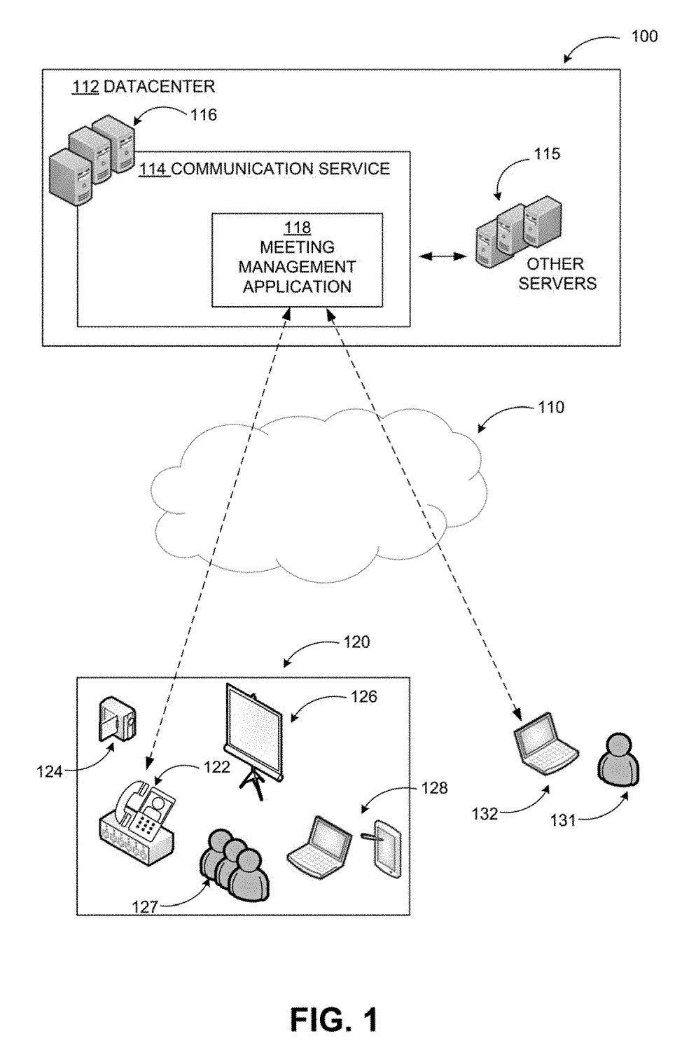

FIG. 1 includes a display diagram illustrating an example network environment where a system for automatic connection switching for meeting room management devices may be implemented.

As illustrated in diagram 100, an example system may include a datacenter 112 hosting a cloud-based communication service 114 configured to enable users to share content, interact and communicate with one another, create and share calendars, and schedule meetings, among other things, through various communication modes, such as e-mail, text message, call and video conferencing and the like. The datacenter 112 may include one or more processing servers 116 configured to execute the communication service 114, among other components. In some embodiments, at least one of the processing servers 116 may, be operable to execute an optional meeting management application 118 of the communication service 114, where the meeting management application 118 may be integrated with the communication service 114 to reserve/facilitate meetings that may involve a meeting space 120 for one or more users 127 through a meeting room management device 122 located within the meeting space 120. The datacenter 112 may also include one or more other servers 115 configured to execute related applications and services such as cloud storage, security, and others. As described herein, the communication service 114 and/or meeting management application 118 may be implemented as software, hardware, or combinations thereof.

In some embodiments, the communication service 114 may be configured to intemperate with various applications to provide its services. For example, a thin (e.g., a web browser) or a thick (e.g., a locally installed client application) version of a client application may be executed by the meeting room management device 122 with which the communication service 114 may be configured to integrate and intemperate with over one or more networks, such as network 110. The meeting room management device 122 may exchange information via wired or short range communication with ancillary devices 124, 126, and client devices 128 in the meeting space 120 to facilitate the meeting. The meeting management device 122 may include special purpose device with custom hardware and/or software components, as well as, a desktop computer, a laptop computer, a tablet computer, a smart phone, and a wearable computing device with custom components among other similar devices. If the meeting is an online meeting, a user 131 that is not within the meeting space 120 may also participate through their client device 132.

As shown in diagram 100, the meeting room management device 122 may, for example, manage the ancillary devices 124, 126 in the meeting space 120 to provide a user interface to access or initiate a meeting, and manage meeting features such as audio/video controls, presentations, recordings, etc. The meeting room management device 120 may communicate with the ancillary devices 124, 126 via short range wireless communication such as include near field communication (NFC), Bluetooth communication, personal area network (PAN) communication, optical communication, and comparable ones. The meeting room management device 122 may also communicate with the ancillary devices via wired communications, for example, universal serial bus (USB) or similar connection.

Embodiments as described herein, allow automatic connection switching for meeting room management devices. The automated switching between the meeting room management device and client devices may reduce processing and memory resources, reduce consumed bandwidth, and increase user interactivity.

Embodiments, as described herein, address a need that arises from very large scale of operations created by software-based services that cannot be managed by humans. The actions/operations described herein are not a mere use of a computer, but address results of a system that is a direct consequence of software used as a service offered in conjunction with large numbers of users participating in meetings through communication services.

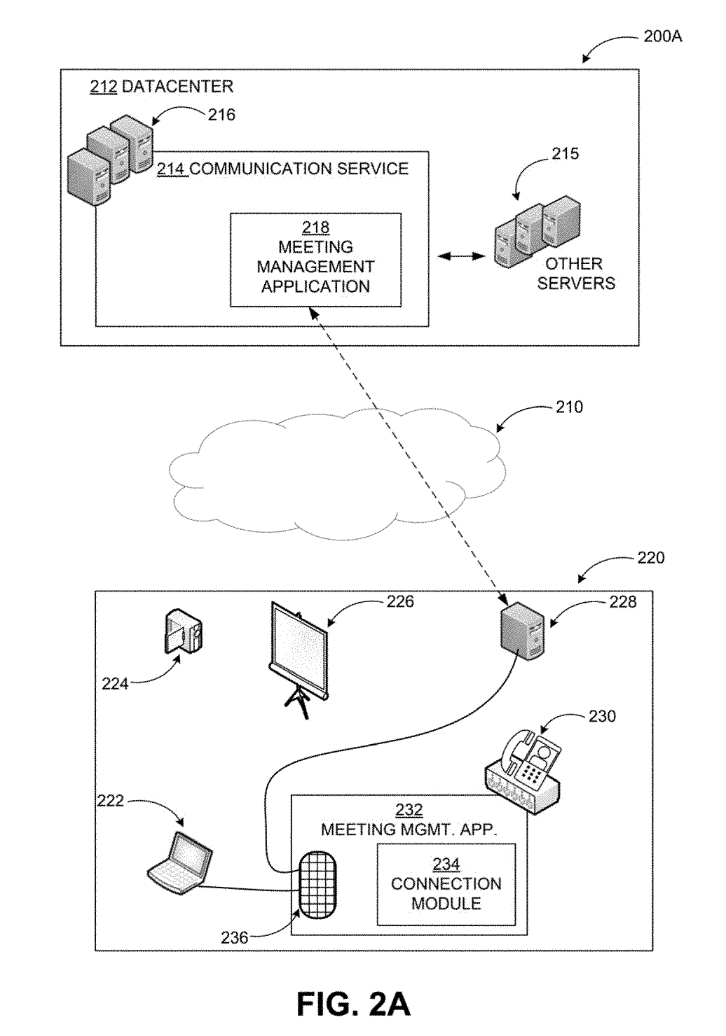

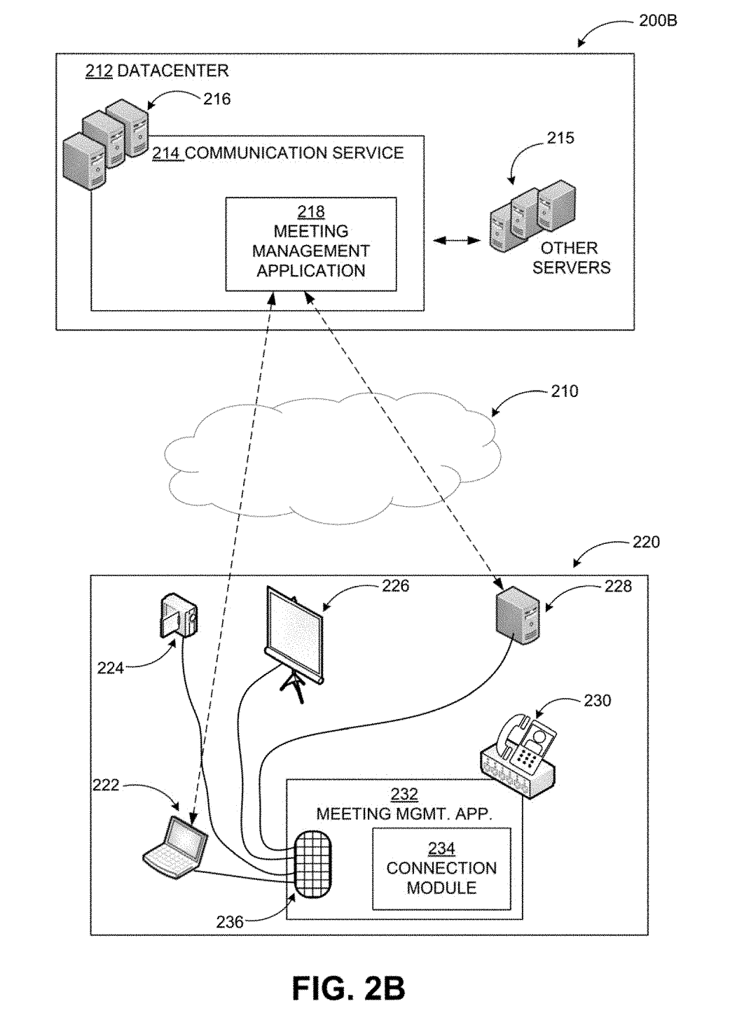

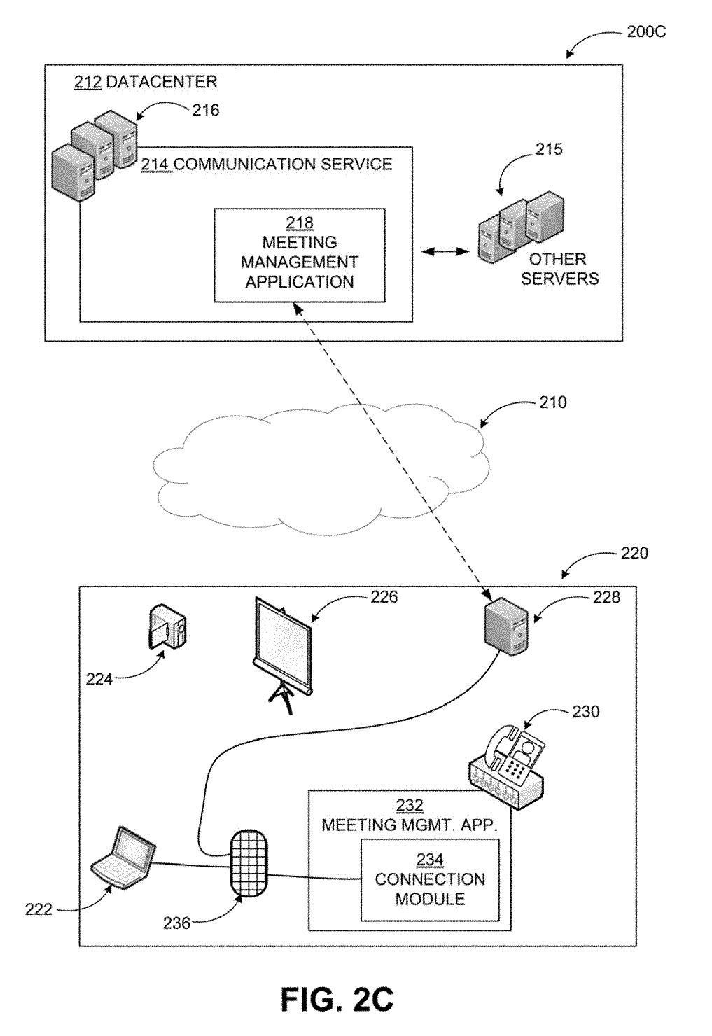

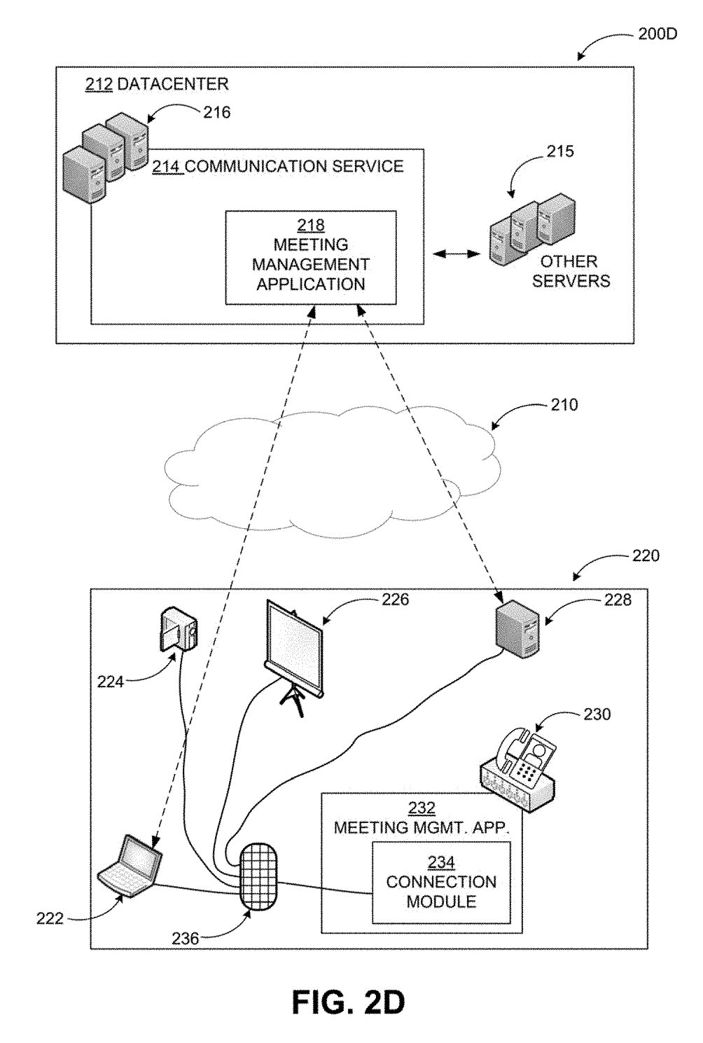

FIG. 2A includes a display diagram conceptually illustrating automatic connection switching from a meeting room management device to a client device through a connection module integrated into a meeting room management device.

Diagram 200A shows an environment similar to that of FIG. 1, where a datacenter 212 includes communication service 214 executed on one or more servers 216 and complementary services executed on other servers 215. A meeting management application 218 executed as part of the communication service 214 may communicate with applications or modules executed on other devices over network 210 to facilitate meetings with online components.

In the illustrated example, meeting space 220 includes an in-room computing device such as server 228. Server 228 may manage communications with communication service 214. In such a configuration meeting room management deice 230 may execute a meeting management application (local) 232 and communicate with communication service 214 over the server 228. The meeting room management device 230 may include a hardware connection module 236, which may be managed by a software connection module 234 within the meting management application ., The connection module 236 may provide connections such as serial or parallel ports, optical connectors, etc. for connection to server 228 and other devices in the room.

According to some embodiments, the connection module 234 may detect connection of a client device 222 to the connection module 236 by detecting a mechanical (or physical) connection or sensing voltage or current in a connection line. Upon detecting the connection of the client device 222, the connection module may determine that the client device 222 is capable of facilitating an online meeting, and disengage, the meeting room management device 230 from the connection to the server 228 (at least partially) such that the client device 222 can take over and facilitate the meeting. The meeting space 220 may also include ancillary devices such as a camera 224 and a display 226, for example.

FIG. 213 includes a display diagram conceptually illustrating automatic connection switching from a meeting room management device to a client device through a connection module integrated into a meeting, room management device, where in-room ancillary devices are allowed to maintain their separate connection to the network.

Diagram 200B shows a variation of the configuration of FIG. 2A, where the ancillary devices camera 224 and display 226 are connected to (and managed by) the server 228 through the connection module 236 of the meeting room management device 230. The ancillary devices may also include audio components such as a microphone or speakers, environmental controls (e.g., lighting, shading, etc.), as well as, printers, scanners, and similar devices.

In the example scenario of diagram 200B, upon detecting the connection of the client device 222, the connection module 234 may disengage the meeting room management device 230 from the server 228, but may leave the ancillary devices (camera 224, display 226, etc.) connected. Thus, the client device 222 may facilitate the meeting in conjunction with the in-room ancillary devices (instead of its own audio video devices, for example). In yet other examples, the ancillary devices may be cross-connected to the client device 222 and directly managed by the client device.

In another example scenario, the in-room ancillary devices may be switched from the server 228 to the client device 222 such that the computing device 222 can facilitate the meeting through its own connection (e.g., wireless network) to the network and not through the server 228.

FIG. 2C includes a display diagram conceptually illustrating, automatic connection switching from a meeting room management device to a client device through a separate connection module.

Diagram 200C shows a further variation of the configuration of FIG. 2A, where the connection module 236 is not integrated to the meeting room management device 230, but a separate hardware module that may connect to the meeting room management device similar to the connection of other devices in the meeting space 220. The hardware connection module 236 may be managed by an internal controller, a software connection module 234 executed by the meeting room management device 230, or by the server 228. The disengagement of the meeting room management device 230 and establishment of the connection between the client device 22 and the server 218 to allow the client device 222 to manage the meeting may be performed similarly to the other scenarios discussed herein. The connection module 236 may switch the connections through relays, solid state switches, and comparable components. The connections, as discussed previously, may include serial connections (e.g., USB), parallel connections, and others.

FIG. 2D includes a display diagram conceptually illustrating automatic connection switching from a meeting room management device to a client device through a separate connection module, where in-room ancillary devices are allowed to maintain their separate connection to the network.

Diagram 200D shows yet another variation of the configurations of FIG. 2A, 2B, and 2C, where the connection module 236 is a separate module and the ancillary devices camera 224 and display 226 are connected separately to/managed by the server 228. The configurations in diagrams 200A through 200D are example configurations for illustration purposes.

In another example scenario, the in-room ancillary devices may be switched from the server 228 to the client device 222 such that the computing device 222 can facilitate the meeting through its own connection (e.g., wireless network) to the network and not through the server 228. Other configurations with fewer or additional devices, different connections types, integrated or separate modules, etc. may also be implemented using the principles described herein.

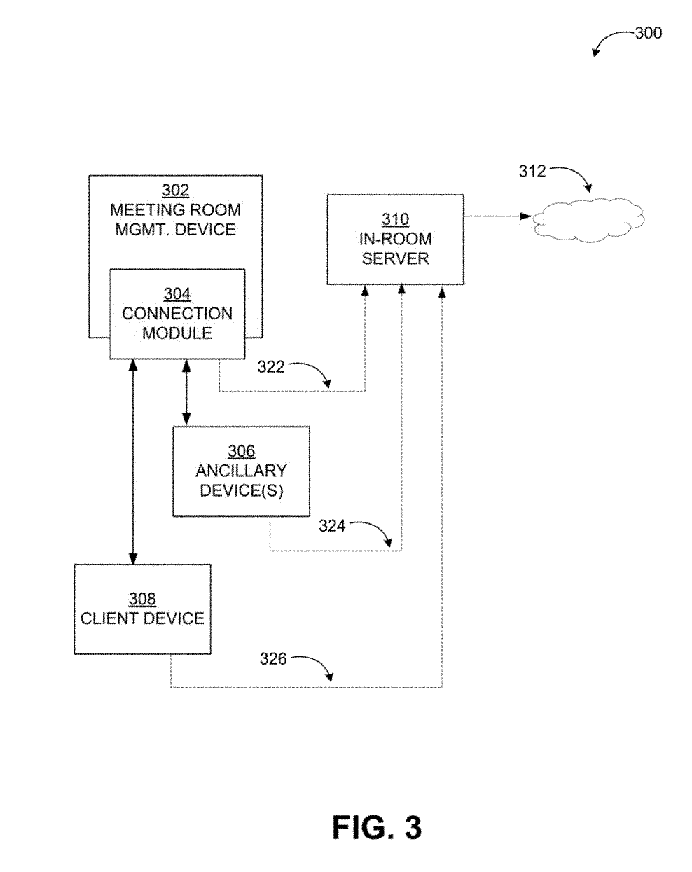

FIG. 3 includes a display diagram illustrating conceptually an example set of actions and components for implementing automatic connection switching for meeting room management devices.

As shown in diagram 300, a meeting room management device 302 may include an integrated or communicatively coupled (separate) connection module 304. The connection module 304 may provide connectivity to a network for facilitating an online meeting via in-room server 310 or directly. Upon detecting a connection of a client device 308 to the connection module 304, the meeting room management device 302 may be disengaged (322) from the server 310 at least partially and the client device 308 allowed (326) to facilitate the meeting through connection to the network (directly or via server 310). In some examples, some connectivity of the meeting room management device to the network may be preserved for non-meeting related tasks such as maintaining a calendar, task list, etc.

In other examples, ancillary devices 306 such as audio/video input and output devices or others may be disengaged (324) from the meeting room management device 302 (or server 310) as well upon connection of the client device 308 or kept connected to allow the client device 308 to facilitate the meeting using the ancillary devices 306.

The examples provided in FIGS. 1 through 3 are illustrated with specific systems, services, applications, and user interface displays. Embodiments are not limited to environments according to these examples. Automatic connection switching for meeting room management devices may be implemented in environments employing fewer or additional systems, services, applications, and user inter lace displays. Furthermore, the example systems, services, applications, and user interface displays shown in FIGS. 1 through 3 may be implemented in a similar manner with other user interface or action flow sequences using the principles described herein.

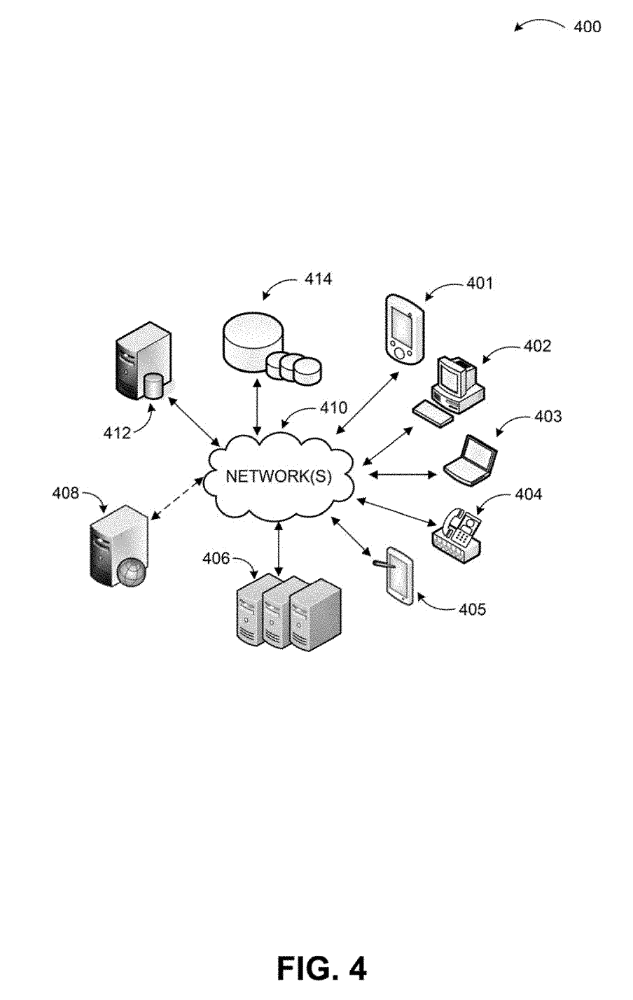

FIG. 4 is a networked environment, where a system according to embodiments may be implemented.

An automatic connection switching for meeting room management, devices as described herein may be employed in conjunction h hosted applications and services (for example, a meeting management service that may be implemented via software executed over one or more servers 406 or individual server 408, as illustrated in diagram 400, may control disengagement and establishment of connections between different devices in a meeting room to the meeting management service. A hosted service or application may communicate with client applications on individual computing devices such as a handheld computer 401 a desktop computer 402 a laptop computer 403, a meeting room, management device 404, a tablet computer (or slate), 405 (‘client devices’) through network(s) 410 and control a user interface presented to users.

Client devices 401-405 are used to access the functionality provided by the hosted service or client application. One or re of the servers 406 or server 408 may be used to provide a variety of services as discussed above. Relevant data may be stored in one or more data stores (e.g. data store 414), which may be managed by any one of the servers 406 or by database server 412.

Network(s) 410 may comprise any topology of servers, clients, Internet service providers, and communication media. A system according to embodiments may have a static or dynamic topology. Network (s) 410 may include a secure network such as an enterprise network, an unsecure network such as a wireless open network, or the Internet. Network(s) 410 may also coordinate communication over other networks such PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, engines, data sources, and data distribution systems may be employed to implement automatic connection switching for meeting room management devices. Furthermore, the networked environments discussed in FIG. 4 are for illustration purposes only. Embodiments are not limited to the example applications engines, or processes.

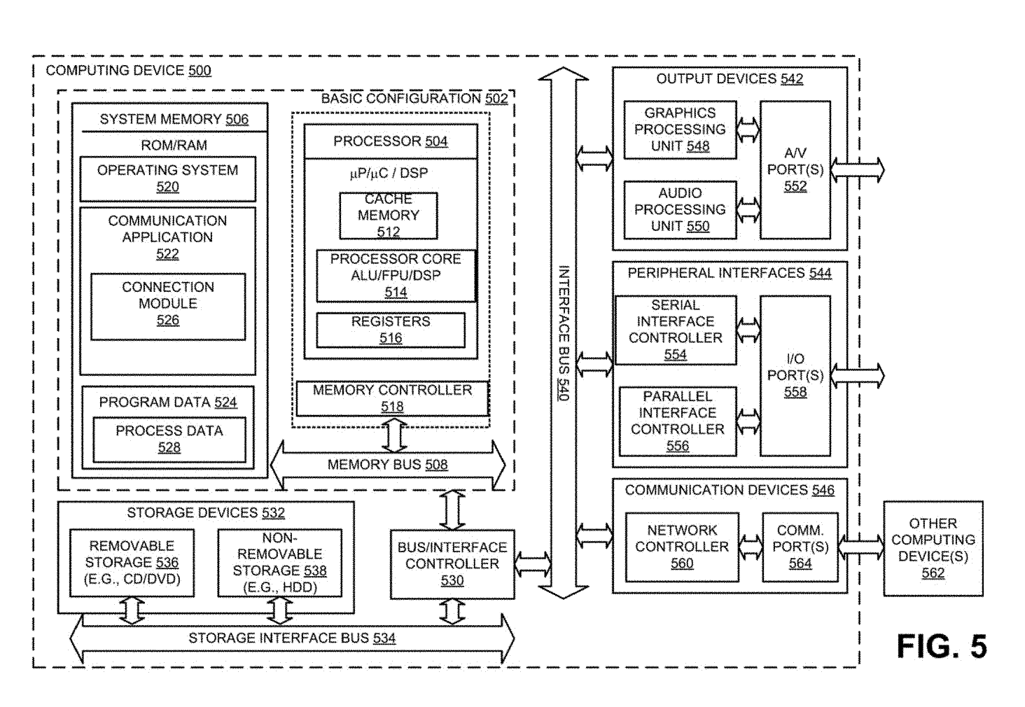

FIG. 5 is a block diagram of an example computing device, which may be used to implement automatic connection switching for meeting room management devices.

For example, computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including hat not limited to volatile memory (such as RAM), non-volatile memory (such as ROM, flash memory, etc.) or any combination thereof. The system memory 506 may include an operating system 520, a communication application 522, and program data 524. The communication application 522 may include connection module 526, which may be an integrated module or a separate module communicatively coupled to the computing device 500. The communication module 526 may be configured to detect a connection of a client device capable of facilitating an online meeting to the connection module based on detection of a mechanical connection of the client device to the connection module or sensing of a voltage in a connection line of the connection module. The connection module 526 may then disengage the meeting room management device at least partially from a connection to a network associated with facilitating the online meeting and allow the client device to connect to the network such that the client device facilitates the online meeting. The program data 524 may include, among other data, process data 528, such as connection configurations, network parameters, etc., as described herein.

The computing device 500 may have additional features or functionality, and additional interfaces to facilitate communications between the basic configuration 502 and any desired devices and interfaces. For example, a bus interlace controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 546) to the basic configuration 502 via the bus/interface controller 530. Some of the example output devices 542 include a graphics processing unit 548 and an audio processing unit 550, which may be configured to communicate, to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example con device 546 includes a network controller 560, which may be arranged to facilitate communications with one or more other computing devices 562 over a network communication link via one or more communication ports 564. The one or more other computing devices 562 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part Of a general purpose or specialized server, mainframe, or similar computer that includes any of the above functions. The computing device 500 may also be implemented as a personal computer including both laptop computer and non-laptop computer configurations.

Example embodiments may also include methods to implement automatic connection switching for meeting room management devices. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

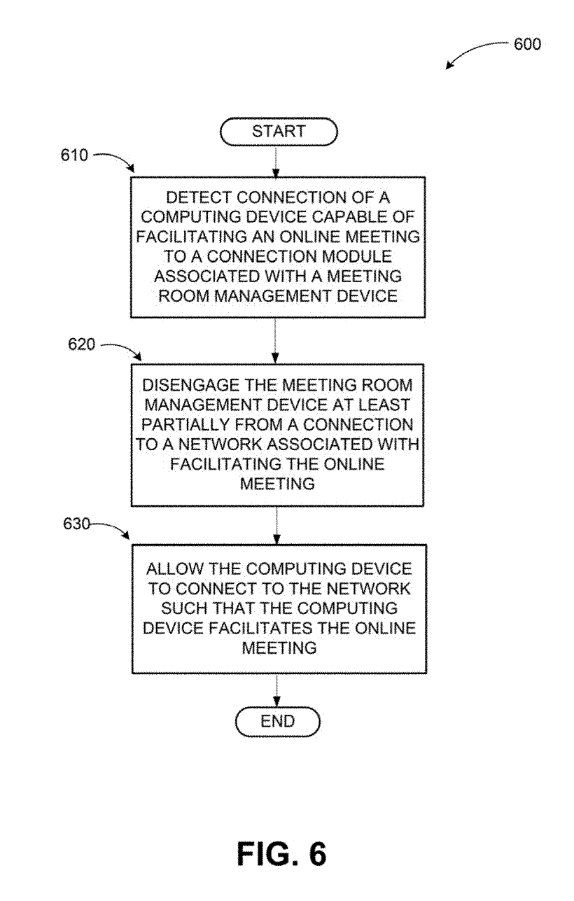

FIG. 6 illustrates a logic flow diagram of a method to implement automatic connection switching for meeting room management devices, arranged in accordance with at least some embodiments described herein.

Process 600 may be implemented on a meeting room management device, a computing device, a server, or other system. An example meeting room management device may be configured to facilitate online meetings and manage a connection module, and include a communication interface to facilitate communication between the meeting room management device, the server, and one or more client devices. The example meeting room management device may also comprise a memory to store instructions, and one or more processors coupled to the memory. The processors, in conjunction with the instructions stored on the memory, may be configured to provide automatic connection switching.

Process 600 begins with operation 610, where the processors may be configured to detect a connection of a client device capable of facilitating an online meeting to the connection module, for example, based on detection of a mechanical connection of the client device to the connection module or sensing of a voltage in a connection line of the connection module.

At operation 620, the processors may be configured to disengage the meeting room management device at least partially from a connection to a network associated with facilitating the online meet ng Thy processors may allow the client device to connect to the network such that the client device facilitates the online meeting at operation 630.

In another example scenario (a subset of the example scenarios discussed above), in-room ancillary devices (e.g., audio/video devices) may be connected to an in-room server by default. Upon detecting connection of a client computing device to the connection module, the module or the meeting room management device/server controlling the module may connect the in-room ancillary devices to the client computing device such that the client computing device can facilitate the meeting through its own network connection (e.g., wireless) using the in-room ancillary devices.

The operations included in process 600 are for illustration purposes. Providing automatic connection switching for meeting room management devices may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to examples, a means for implementing automatic connection switching for meeting room management devices is described. The means may include a means for detecting a connection of a computing device capable of facilitating an online meeting to a connection module associated with a meeting room management device; a means for disengaging the meeting room management device at least partially from a connection to a network associated with facilitating the online meeting; and a means for allowing the computing device to connect to the network such that the computing device facilitates the online meeting.

According to some examples, a method to implement automatic connection switching for meeting room management devices is described. The method may include detecting a connection of a computing device capable of facilitating an online meeting to a connection module associated with a meeting room management device; disengaging the meeting room management device at least partially from a connection to a network associated with facilitating the online meeting; and allowing the computing device to connect to the network such that the computing device facilitates the online meeting.

According to other examples, detecting the connection of the computing device to the connection module may include detecting a mechanical connection of the computing device to the connection module. Detecting the connection of the computing device to the connection module may also include sensing a voltage in a connection line of the connection module. Disengaging the meeting room management device at least partially from the connection to the network associated with facilitating the online meeting may include severing a communicative coupling between the meeting room management device and a server coupled to the network. The communicative coupling may be a wired connection or a wireless connection.

According to further examples, the method may also include detecting an ancillary device communicatively coupled to the network through the connection module; and determining whether to disengage the ancillary device from the network based on a capability of the computing device. The ancillary device may be an audio input device, an audio output device, a video input device, a video output device, or an environmental control device. The method may further include disengaging the ancillary device from the meeting room management device based on the determination. The method may also include establishing communicative coupling between the ancillary device and the computing device such that the computing device facilitates the online meeting in conjunction with the ancillary device.

According to other examples, a meeting room management device to implement automatic connection switching is described. The meeting room management device may include a communication interface configured to facilitate communication between the meeting room management device, a server, and one or more client devices; a connection module configured to provide connectivity to the server and the one or more client devices; a memory configured to store instructions; and a processor coupled to the communication interface, the communication module, and the memory. The processor may be configured to detect a connection of a client device capable of facilitating an online meeting to the connection module based on one of detection of a mechanical connection of the client device to the connection module and sensing of a voltage in a connection line of the connection module; disengage the meeting room management device at least partially from a connection to a network associated with facilitating the online meeting; and allow the client device to connect to the network such that the client device facilitates the online meeting.

According to some examples, the client device and the server may be connected to the connection module through a serial connection. The processor may be configured to disengage the meeting room management device and allow the client device to connect to the network through activation of a relay or a solid s switch. The meeting room device may further include one or more of an audio input device, an audio output device, a video input device, and a video output device to facilitate the online meeting in one or more of an audio modality, a video modality, a desktop sharing modality, and an application sharing modality. The processor may be further configured to detect an ancillary device communicatively coupled to the network through the connection module; determine whether to disengage the ancillary device from the network based on a capability of the client device; and establish communicative coupling between the ancillary device and the client device such that the client device facilitates the online meeting in conjunction with the ancillary device based on the determination. The connection module may be integrated to the meeting room management device or a separate module communicatively coupled to the meeting room management device.

According to further examples, a connection module configured to implement automatic connection switching for meeting room management devices is described. The connection module may include a first connection configured to provide connectivity to a network associated with facilitating an online meeting; a second connection configured to provide connectivity to a meeting room management device; a third connection configured to provide connectivity to a client device; and a controller configured to manage the first, second, and third connections. The controller may be configured to detect a connection of the client device capable of facilitating the online meeting to the third connection; disengage a first coupling between the first connection and the second connection; and establish a second coupling between the first connection and the third connection such that the client device facilitates the online meeting.

According to yet other examples, the controller may be configured to disengage the first coupling and the establish the second coupling based on an instruction received from the meeting room management device. The controller may also be configured to disengage the first coupling and the establish the second coupling based on an instruction received from the client device. One or more of the first connection, the second connection, and the third connection may be wireless. One or more of the first connection, the second connection, and the third connection may be wired.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method to implement automatic connection switching for meeting room management devices, the method comprising:
detecting a connection of a computing device capable of facilitating an online meeting to a connection module associated with a meeting room management device;
disengaging the meeting room management device at least partially from a connection to a network associated with facilitating the online meeting; and
allowing the computing device to connect to the network such that the computing device facilitates the online meeting.

2. The method of claim 1, wherein detecting the connection of the computing device to the connection module comprises:
detecting a mechanical connection of the computing device to the connection module.

3. The method of claim 1, wherein detecting the connection of the computing device to the connection module comprises:
sensing a voltage in a connection line of the connection module.

4. The method of claim 1, wherein disengaging the meeting room management device at least partially from the connection to the network associated with facilitating the online meeting comprises:
severing a communicative coupling between the meeting room management device and a server coupled to the network.

5. The method of claim 4, wherein the communicative coupling is one of a wired connection and a wireless connection.

6. The method of claim 1, further comprising:
detecting an ancillary device communicatively coupled to the network through the connection module; and
determining whether to disengage the ancillary device from the network based on a capability of the computing device.

7. The method of claim 6, wherein the ancillary device is one of an audio input device, an audio output device, a video input device, a video output device, and an environmental control device.

8. The method of claim 6, further comprising:
disengaging the ancillary device from the meeting room management device based on the determination.

9. The method of claim 8, further comprising:
establishing communicative coupling between the ancillary device and the computing device such that the computing device facilitates the online meeting in conjunction with the ancillary device.

10. A meeting room management device to implement automatic connection switching, the meeting room management device comprising:
a communication interface configured to facilitate communication between the meeting room management device, a server, and one or more client devices;
a connection module configured to provide connectivity to the server and the one or more client devices;
a memory configured to store instructions; and
a processor coupled to the communication interface, the communication module, and the memory, the processor configured to:
detect a connection of a client device capable of facilitating an online meeting to the connection module based on one of detection of a mechanical connection of the client device to the connection module and sensing of a voltage in a connection line of the connection module;
disengage the meeting room management device at least partially from a connection to a network associated with facilitating the online meeting; and
allow the client device to connect to the network such that the client device facilitates the online meeting.

11. The meeting room management device of claim 10, wherein the client device and the server are connected to the connection module through a serial connection.

12. The meeting room management device of claim 10, wherein the processor is configured to disengage the meeting, room management device and allow the client device to connect to the network through activation of a relay or a solid-state switch.

13. The meeting room management device of claim 10, further comprising one or more of an audio input device, an audio output device, a video input device, and a video output device to facilitate the online meeting in one or more of an audio modality, a video modality, a desktop sharing modality, and an application sharing modality.

14. The meeting room management device of claim 10, wherein the processor is further configured to:
detect an ancillary device communicatively coupled to the network through the connection module;
determine whether to disengage the ancillary device from the network based on a capability of the client device; and
establish communicative coupling between the ancillary device and the client device such that the client device facilitates the online meeting in conjunction with the ancillary device based on the determination.

15. The meeting room management device of claim 10 wherein the connection module is one of integrated to the meeting room management device and a separate module communicatively coupled to the meeting room management device.

16. A connection module configured to implement automatic connection switching for meeting room management devices, the connection module comprising:
a first connection configured to provide connectivity to a network associated with facilitating an online meeting;
a second connection configured to provide connectivity to a meeting room management device;
a third connection configured to provide connectivity to a client device; and
a controller configured to manage the first, second, and third connections, wherein the controller is configured to:
detect a connection of the client device capable of facilitating the online meeting to the third connection;
disengage a first coupling between the first connection and the second connection; and
establish a second coupling between the first connection and the third connection such that the client device facilitates the online meeting.

17. The connection module of claim 16, wherein the controller is configured to disengage the first coupling and the establish the second coupling based on an instruction received from the meeting room management device.

18. The connection module of claim 16, wherein the controller is configured to disengage the first coupling and the establish the second coupling based on an instruction received from the client device.

19. The connection module of claim 16, wherein one or more of the first connection, the second connection, and the third connection are wireless.

20. The connection module of claim 16, wherein cage or more of the first connection, the second connection, and the third connection are wired.
